(19) United States
(12) Patent Application Publication
(10) Pub. No.: US 2004/0027255 A1
(43) Pub. Date: Feb. 12, 2004

(54) Wideband avionics data retrieval system

(76) Inventor: Myron H. Greenbaum, South Orange, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/086,586

(22) Filed: Mar. 1, 2002

(51) Int. Cl. G08B 21/00

(52) U.S. Cl. 340/945

(57) ABSTRACT

An aircraft operation data transmission and retrieval system. The system includes one or more black boxes, such as a flight data recorder or a cockpit voice recorder, that stores aircraft operational data received from sensors on the aircraft. A flight data acquisition unit that is connected to sensors around the aircraft may provide the aircraft operational data. The black boxes store data during a flight that, in the event of an accident, can assist investigators in determining the cause of the accident. If the aircraft systems or the pilots believe that an accident is about to occur, a triggering device is activated to cause the black boxes to output their data to a formatting device. This can occur when an abnormal operating condition is sensed by one or more of the sensors. The data is then formatted and sent to a transmitter for wireless transmission. Formatting can include data compression and the insertion of error correction codes. Either a ground based receiver or a satellite receiver receives the data, thereby allowing for the efficient and effective retrieval of aircraft operational data.

### BACKGROUND OF THE INVENTION

The present invention relates to the wireless transmission of aircraft operational data from an aircraft.

Aircraft typically include black boxes to record various types of aircraft operational data. These black boxes are manufactured to survive the extreme stresses often present during an accident, and thereby allow investigators to determine the events that occurred prior to the accident to ascertain the cause of the accident. The black boxes have proven very useful to investigators, particularly when the evidence concerning the crash is transitory, for example, as often occurs in high windshear conditions. Presently, most commercial aircraft are required to have these devices installed.

Two types of black boxes are typically found in commercial aircraft: a flight data recorder and a cockpit voice recorder. These devices are designed to record critical aircraft operational data that may be useful in determining the flight status in the time period immediately preceding an accident. These black boxes include a crash-survivable memory that is designed to withstand the high pressures and temperatures often associated with an accident, and are typically located in the rear of the aircraft to enhance their ability to survive an accident.

These black boxes are generally connected to, and receive data from, a flight data acquisition unit that acquires data collected by the sensors located throughout an aircraft. So, for example, the flight data recorder may receive and record, among other things, the time, the altitude, the airspeed, the vertical acceleration, the magnetic heading, the control-column position, the rudder-pedal position, the status of the horizontal stabilizer and the fuel flow. The cockpit voice recorder typically receives data through the flight data acquisition unit from microphones located in the cockpit. These microphones are usually located in the pilot's, the co-pilot's and a third crew member's headsets. Another microphone is typically located in the center of the cockpit, and is designed to pick up ambient noises, such as the throwing of a switch.

Each of these devices, the flight data recorder and the cockpit voice recorder, either use magnetic tape or solid-state memory boards in their crash-survivable memories to record data. The flight data recorders that utilize magnetic tape recording systems can track about one hundred parameters, while those using solid-state recording systems can track more parameters. The cockpit voice recorders that utilize magnetic tape recording systems can typically store about thirty minutes of voice while those that use solid-state recording systems can store up to two hours.

While these black boxes often provide valuable data to accident investigators, there are significant problems with their use. The first problem is that black boxes can be difficult to locate after an accident. This problem has been inadequately addressed by painting the black boxes bright orange, by taping reflective tape on the exterior of the devices and by incorporating an underwater locator beacon in the black boxes that is activated in water. Despite these efforts, it often takes investigators a long time to locate these devices after an accident. Further, despite the significant survivability design efforts associated with the black boxes, there are always concerns about whether the devices actually survived a crash, or whether any data on the devices was damaged by the crash.

Accordingly, systems and methods to allow data from black boxes on aircraft to be provided to investigators more effectively and more efficiently are needed.

### SUMMARY OF THE INVENTION

The present invention includes systems and methods that provide for the retrieval of aircraft operational data from an aircraft. The systems and methods of the present invention provide for the immediate transmission and recovery of critical aircraft operational data from black boxes located within an aircraft. The transmission of the data is preferably enabled when one or more sensors sense the occurrence of a predetermined event, such as an abnormal operating condition in an aircraft.

In accordance with a preferred embodiment of the present invention, one or more black boxes located on an aircraft receives aircraft operational data from one or more operational data sensors. This data is received usually, but not necessarily, through a flight data acquisition unit. The black box stores the aircraft operational data in a crash-survivable memory that generally includes a tape storage device, but can also include a solid-state memory device. An accident sensor senses when an accident is either about to occur or is in the process of occurring, preferably by sensing the occurrence of a predetermined event, such as the occurrence of an abnormal operating event. When the accident sensor senses the abnormal operating event, it generates a signal that causes the aircraft operational data stored in the crash-survivable memory of the black box to output the critical aircraft operational data.

Once the signal is sent by the accident sensor, in accordance with a preferred embodiment, the aircraft operational data is preferably transmitted from the black box to a processor/modem. The processor/modem formats the critical aircraft operational data for wireless transmission. It is preferable that the formatting of the data includes the use of data compression techniques and the insertion of error correction encoding to the signal representing the critical aircraft operational data.

Well-known data compression techniques and error correcting techniques can be used by the processor/modem to compress and process the data being transmitted. The compression of the aircraft operational data can be either on a continuous or one-time basis, and further can be performed before or after the aircraft operational data is stored by a black box. The primary purpose of the data compression is to allow the data to be transmitted from the aircraft to a receiving station in a very short time interval. Such transmission would be effected when an accident is either about to occur or is in the process of occurring, and is preferably accomplished quickly, since there may not be much time to effect the transmission in an accident scenario.

Once the aircraft operational data is processed by the processor, it is sent to one or more wireless transmitters. The wireless transmitters then transmit the aircraft operational data from the aircraft. It is preferred to send an aircraft identification signal with the transmitted aircraft operational data to enable received data to be associated with a known plane. Preferably, burst transmission techniques are used. The transmitted data is received by a satellite receiver or by a ground based receiver system, and is available for immediate analysis. In accordance with one embodiment, a plurality of wireless transmitters are used to transmit the critical aircraft operational data. Each of the plurality of transmitters can transmit all or part of the aircraft operational data. Where a plurality of transmitters is used, the transmitters each preferably transmit in a different frequency.

The transmitted aircraft operational data is received by one or more receivers. In one embodiment of the present invention, the receivers are ground based. In another embodiment, the receivers are satellite based. Alternatively, both ground based receivers and satellite receivers can be used to receive the data.

### BRIEF DESCRIPTION OF THE DRAWINGS

FIG. 1 illustrates an installation of the data retrieval system of the present invention in an aircraft;

FIG. 2 illustrates a block diagram of the data retrieval system in accordance with the present invention;

FIG. 3 illustrates a block diagram of a black box in accordance with a preferred embodiment of the present invention; and

FIGS. 4 and 5 illustrate block diagrams of the data retrieval system in accordance with alternate embodiments of the present invention.

### DETAILED DESCRIPTION OF THE PREFERRED EMBODIMENT

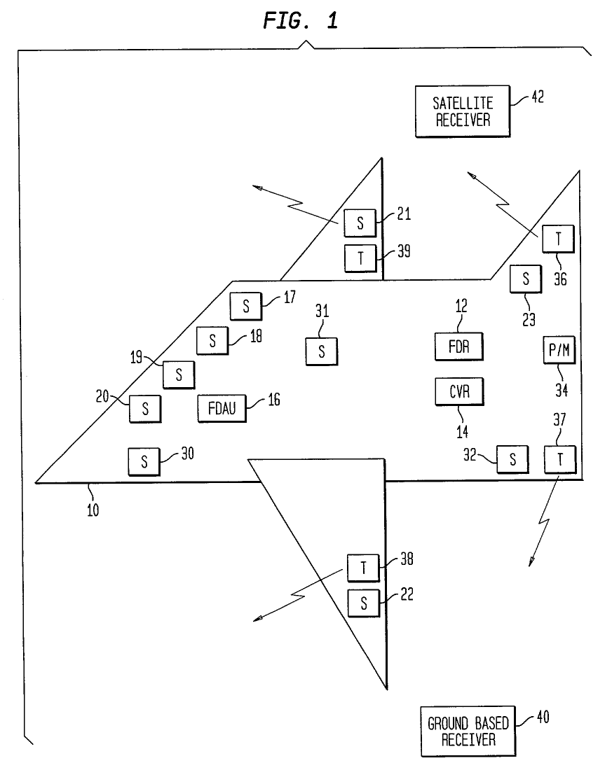

Referring to FIG. 1, an aircraft 10 having a data transmission and retrieval system according to one embodiment of the present invention is illustrated. The system operates to provide for the fast transmission of aircraft operational data just before an accident occurs, and the subsequent retrieval and availability of critical aircraft operational data, particularly the data provided by aircraft black boxes, during situations where an accident is occurring or is likely to occur. The system thus provides investigators from government agencies, such as the National Transportation Safety Board (NTSB) and the Federal Aviation Administration (FAA), who are tasked with investigating the cause of aircraft accidents, with an early look at critical data regarding the events that led up to an accident. The often-difficult procedure of recovering and retrieving the black boxes becomes less important.

The system operates to sense the onset of an accident and to cause the aircraft operational data, which includes critical operational data, stored in black boxes to be wirelessly transmitted from the aircraft 10 to one or more receivers located off the aircraft 10. As shown in FIG. 1, the system includes a variety of components located within an aircraft 10, including: a flight data recorder (FDR) 12, a cockpit voice recorder (CVR) 14, a flight data acquisition unit (FDAU) 16, a plurality of operational data sensors 17 to 23, a plurality of accident sensors 30 to 32 that sense the occurrence of abnormal operational events in an aircraft to indicate the onset of a potential accident, a processor/modem (P/M) 34 that formats signals for wireless transmission, and a plurality of transmitters 36 to 39. The receiver system of the present invention includes a ground-based receiver 40 or a satellite receiver 42, or both.

There are typically many more operational data sensors onboard the aircraft 10 than the illustrated operational data sensors 17 to 23. These additional operational data sensors are well known to those skilled in the art. The sensors 17 to 23 and the additional sensors not shown in FIG. 1 can supply data that is recorded by either the flight data recorder 12 or the cockpit voice recorder 14 or by another type of black box. Similarly, there may be many more of the accident sensors located on the aircraft 10 than the illustrated accident sensors 30 to 32.

The flight data recorder 12 and the cockpit voice recorder 14 are generally referred to as “black boxes.” They are generally used to record aircraft operational data supplied by the aircraft operational sensors for a certain length of time, the length of time generally being related to the size of the memory in the black box. Once the memory has been filled with the aircraft operational data, the black box typically starts to store new aircraft operational data by overwriting the previously stored data. Thus, the black boxes provide a snapshot of an aircraft's operating characteristics for a certain time period. These black boxes are typically located in the rear of the aircraft 10 to assist in the survivability of these devices during an accident.

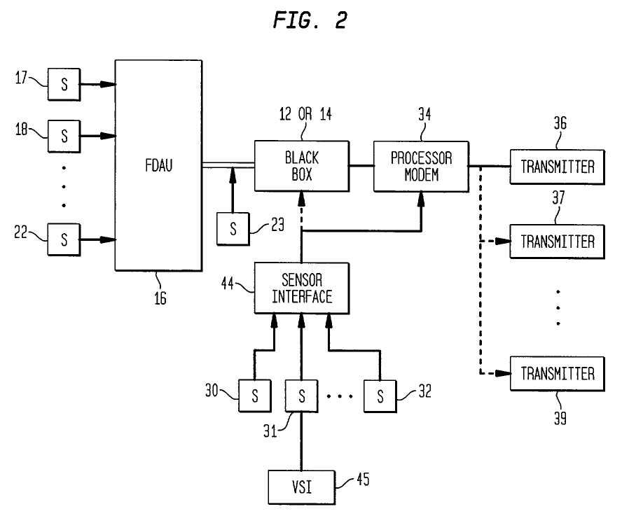

Referring to FIG. 2, a block diagram of the system of FIG. 1 is illustrated. The black box, which can be either the data recorder (FDR) 12 or the cockpit voice recorder (CVR) 14, receives inputs that include aircraft operational data that is detected by the operational data sensors 17 to 22, and that indicate how the aircraft is performing. The aircraft operational data can be supplied through the flight data acquisition unit 16 as indicated by the operational data sensors 17 to 22. The black box 12 or 14 can also receive aircraft operational data from operational data sensors through a bus connection, as indicated by the operational data sensor 23, or through a sensor connected directly to the black box 12 or 14. As mentioned earlier, there are typically many more operational data sensors than those illustrated providing inputs to the flight data acquisition unit 16 and to the black boxes 12 and 14. By way of example only, some of the operational data sensors that provide data to the cockpit voice recorder 14 include the previously mentioned cockpit microphones. Also by way of example only, some of the operational data sensors that provide data to the flight data recorder 12 include the altitude sensor, the airspeed sensor, the vertical acceleration sensor, the magnetic heading sensor, the control-column position sensor, the rudder-pedal position sensor, the status of the horizontal stabilizer sensor and the fuel flow sensor. Other operational data sensors provide additional information. For example, operational data sensors can provide video signals from cameras situated throughout the aircraft. The operational data sensors can also provide voice signals from microphones located throughout the aircraft (in addition to voice signals supplied to the cockpit voice recorder 14). All control data, that is data generated from the aircraft controls, can also be provided by an operational data sensor to the black boxes 12 or 14.

The aircraft 10 also includes a plurality of accident sensors 30 to 32 and an accident sensor interface 44. Each of the plurality of accident sensors 30 to 32 is configured to sense and to indicate the onset of a potential accident condition. When any of the accident sensors 30 to 32 sense the occurrence of an event that indicates the onset of an actual or a potential accident condition, that accident sensor generates a signal that is sent through the switch interface 44 to the black box 12 or 14 or to the processor/modem 34 to cause the output and eventual wireless transmission of the aircraft operational data. The occurrence of the event, which is referred to as an accident event, can be the occurrence of an abnormal operating parameter during aircraft operation that is outside a normal range.

The accident sensors 30 to 32 can be configured to sense the onset of a potential accident condition in a number of different ways, and there can be a number of different sensors that are provided. In general, the accident sensors 30 to 32 sense when an accident is occurring or is about to occur by sensing the occurrence of a predetermined event. In a preferred embodiment, the occurrence of a predetermined event would indicate a likelihood that an accident was occurring or about to occur. By way of example, one of the accident sensors could be a switch located by the pilot or the co-pilot that they switch on when they believe an accident scenario is occurring. Another accident sensor 30 to 32 is a device that is attached to a vertical speed indicator 45 to sense when the vertical speed of the aircraft 10 exceeds normal operation. Another accident sensor is a device that senses when the air speed of the aircraft 10 is outside normal parameters. In conclusion, an accident sensor 30 to 32 can be any aircraft sensor that provides an output when the sensor detects an operating parameter that is outside a normal range, so that the operating parameter is abnormal.

Additionally, the transmission of the aircraft operational data can also be caused by a combination of sensor readings. In this case, it is preferred that the data from the aircraft operational data sensor, or at least the output of the sensor, be provided to a processor, such as the processor/modem 34. Alternatively, the processor can be located in the sensor interface 44. The processor can look for combinations of results from the sensors 30 to 32 to declare the occurrence of an accident event, and to thus cause the transmission of the aircraft operational data.

Additionally, any of the operational data sensors 17 to 23 can also perform as an accident sensor if the operational data sensor 17 to 23 detects when abnormal operational conditions occur. If an operational data sensor 17 to 23 is used as an accident sensor, its output is connected to the sensor interface 44 to provide a trigger that causes the transmission of the information.

In accordance with one embodiment, the aircraft operational data that was stored in the black box 12 or 14 is output to the processor/modem 34 on a continuous basis. The processor/modem 34 formats the aircraft operational data to enable the data to be wirelessly transmitted in an optimal fashion. The formatting preferably includes compressing the aircraft operational data in accordance with well-known data compression techniques and/or inserting error correction codes in the aircraft operational data in accordance with well-known error correction coding techniques. The processor/modem 34 also preferably inserts a signal into the aircraft operational data that identifies the aircraft making the transmission.

Thus, in this embodiment, the processor/modem 34, is continuously compressing the data and/or inserting error correction codes into the data. Thus, when the sensor interface 44 receives a signal from one of the accident sensors 30 to 32 that indicates the occurrence of an event whereby an abnormal operating condition occurred, the sensor interface 44 outputs a signal to the processor/modem 34 that causes the processor/modem 34 to output the already compressed aircraft operational data to one or more transmitters 36 to 39.

In accordance with an alternate embodiment, the processor/modem 34 can wait until it receives a signal from the sensor interface 44 to start compressing the aircraft operational data and inserting error correction codes therein. In accordance with another alternate embodiment, the output from the sensor interface 44 can be provided directly to the black box 12 or 14. In this case the aircraft operational data is not output from the black box 12 or 14 to the processor/modem 34 until the signal is received from the sensor interface 44. Once the sensor interface 44 outputs the signal to the black box 12 or 14, the aircraft operational data is output to the processor/modem 34, where it is compressed, and error correction codes can optionally be inserted. Once the processor/modem 34 has completed its task, the signal is outputted automatically to one or more transmitters 36 to 39. Additionally, the black box 12 or 14, upon receiving a signal from the sensor interface 44 that indicates that aircraft operational data should be wirelessly transmitted from the aircraft 10, can transmit its data directly to one or more of the transmitters 36 to 39. Further, the processing functions of the processor/modem 34 can be included in the black box 12 or 14, and the black box 12 or 14 can output directly to one or more transmitters 36 to 39 upon being triggered by the sensor interface 44.

It should be appreciated that the aircraft operational data can also be compressed prior to being stored in one of the black boxes 12 or 14. Of course, while data compression is not required, without data compression the system will suffer from being able to transmit less data in a given time. As such, it is preferred to utilize data compression in the present invention.

As illustrated in FIG. 2, data from the processor/modem 34 is sent through the processor/modem 34 to at least one transmitter 36 for wireless transmission to a receiver station. The aircraft operational data can also be sent to a plurality of transmitters 36 to 39. The plurality of transmitters 36 to 39 can be configured so that each transmitter transmits the entire set of aircraft operational data that is output from the black box 12 or 14, thereby providing redundancy. Alternatively, each of the plurality of transmitters 36 to 39 can be configured to transmit a portion of the aircraft operational data output by the black box 12 or 14. By partitioning the transmission of the aircraft operational data by the transmitters 36 to 39, greater effective bandwidth can be achieved to transmit a greater amount of aircraft operational data within a given time period. Where a plurality of transmitters 36 to 39 transmit the aircraft operational data at the same time, it is preferred to utilize frequency diversity, whereby each transmitter 36 to 39 transmits on a different frequency. The receiver station that receives the aircraft operational data may either be a ground based receiver station 40 or a satellite receiver 42 or another receiver at a different location than the aircraft 10.

During an accident scenario, there is generally little time between the onset of the situation that is creating the potential accident and an actual crash of an aircraft. Accordingly, to be effective, the transmission of the aircraft operational data will likely be time critical. Thus, it can be important that the data from the black box be transmitted in a short time frame.

The importance of compressing data to meet the potentially short time frame has been noted. It is believed that the lower limit on transmission time would be in the 0.01 second to 0.1 second time frame, and would occur in a catastrophic event such as a collision. It is thus preferred to provide as much data compression as possible. For example, a compression ratio of approximately 1000 times will allow data that is recorded over a ten second period to be transmitted over a 0.01 second period.

One simple way to compress the data is to clock the data in from the operational data sensors 17 to 23 at one rate and then clock the data out for transmission by the wireless transmitters 36 to 39 at a much faster rate. For example, if data is sampled digitally at 2 kHz rate for one second, 2000 digital samples will result. Once stored, that data can be clocked out in 0.1 seconds, or faster, by applying a faster clock to clock the data out. A First-In First-Out (FIFO) device can be used to implement this type of compression.

Other standard forms of mathematical data compression can be used to compress the operational data that is stored in the black box 12 or 14. Further, the previously mentioned frequency diversity transmission techniques can also be used to achieve greater bandwidths of transmission. Similarly, standard and well-known forms of error correction coding can be used in accordance with the present invention.

With respect to the transmitters 36 to 39, it is preferred to use a transmitter having a wide bandwidth and that implements burst transmission techniques. The bandwidth must be large enough to accommodate the short time, burst requirements of the data transmission. A number of power devices, in the one to ten watt range, are available to accommodate the required bandwidths. These include traveling wave tube amplifier vacuum devices, gallium arsenide and gallium nitride solid-state amplifier devices. Maximum bandwidths available from these devices range from four to fifteen GHZ within the microwave frequencies (i.e. 2 to 20 GHZ). A number of antennas are available that can radiate these bandwidths at the indicated power levels. The types of antennas include spirals, horns, and vivaldi notches and four-square elements for arrays. Several transmitter/antennas, located around the aircraft, will be used to remote the data to provide for full spatial coverage and to ensure high system reliability.

As previously mentioned, in the worst case scenario, involving a catastrophic event such as an explosion or unexpected crash, it is expected that there will be 0.01 to 0.1 seconds to transmit the data. The compression techniques, the burst transmission techniques and the use of multiple transmitters to transmit portions of the aircraft operational data should be selected in accordance with the amount of data there is to be transmitted, the system components available and the amount of time expected to be needed to effect the transmission. These parameters are expected to vary somewhat from application to application.

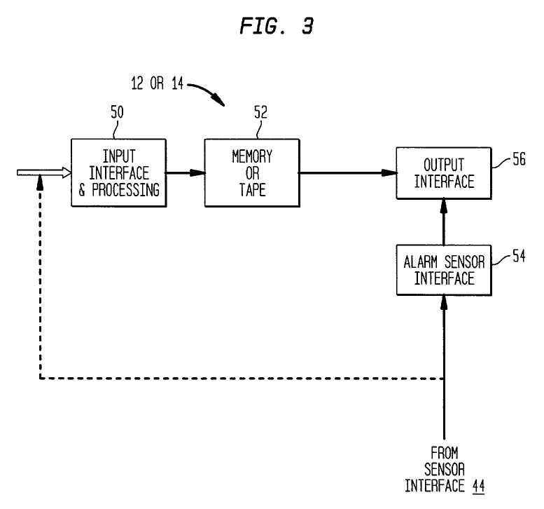

Referring to FIG. 3, a block diagram of the black box 12 or 14 is illustrated. The black box 12 or 14 generally includes an input interface 50 that receives signals from the flight data acquisition unit 16 or from other data sources. The signals received by the black box 12 or 14 are then sent to a crash-survivable memory 52 and stored on either magnetic tape or in a solid-state memory, depending on the type of black box in use. The crash-survivable memory 52 is typically constructed to withstand the immense forces and high temperatures associated with an aircraft accident. It normally includes a stainless steel shell and high temperature insulation to enhance survivability. The black box 12 or 14 also includes an accident sensor interface 54 and an output interface 56, which may have to be added to existing black boxes. When the black box 12 or 14 receives an enabling signal on the accident sensor interface 54 from the sensor interface 44, the black box 12 or 14 causes the aircraft operational data stored in the crash survivable memory 52 to be output from the black box 12 or 14 through the output interface 56. Alternatively, the black box 12 or 14 can be continually outputting to either the processor/modem 34 or to the transmitter.

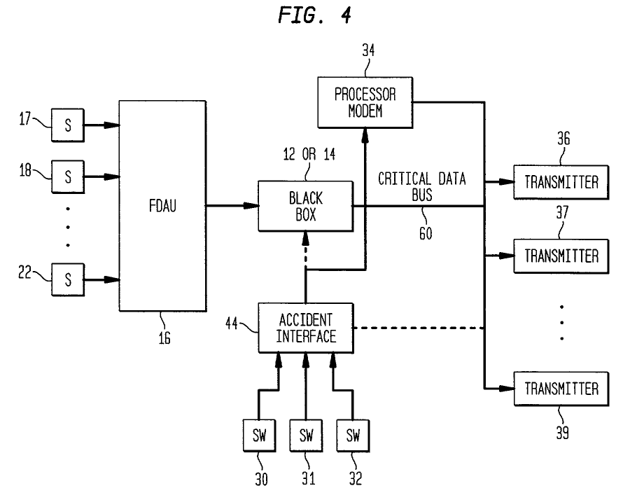

Referring to FIG. 4, the data from the black box 12 or 14, the flight data acquisition unit 16, the plurality of sensors 17 to 23, the plurality of switches 30 to 32 and the switch interface 44 all function and operate as previously described. The processor/modem 34, however, is connected to a critical data bus 60 instead of directly to the black box 12 or 14. The plurality of transmitters 36 to 39 are also connected to the critical data bus 60. Operationally, the system of FIG. 4 functions the same as the system of FIG. 2. The processor/modem 34 receives aircraft operational data from the black box 12 or 14, either continuously or when the sensor interface 44 indicates that an abnormal operating parameter has been sensed by an accident sensor 30 to 32. The aircraft operational data is received, however, on the critical data bus. Further, when the sensor interface 44 indicates that an abnormal operating parameter has been sensed, the processor 44 sends the formatted aircraft operational data to one or more of the transmitters 36 to 39 via the critical data bus.

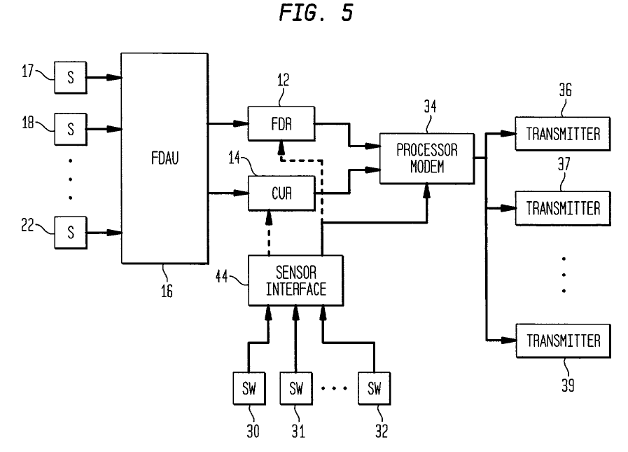

Referring to FIG. 5, the black box is illustrated as including the flight data recorder 12 and the cockpit voice recorder 14. Additional types of black boxes that store aircraft operational data are contemplated by the present invention. The system of FIG. 5 illustrates that data from both the flight data recorder 12 and the cockpit data recorder 14 is sent to the processor/modem 34, either continuously or upon the occurrence of an accident event. The processor/modem 34 formats the data from both recorders 12 and 14 and sends the data to one or more of the transmitters 36 to 39 upon receiving a signal from the sensor interface 44 indicating the occurrence of an accident event.

In addition to the previously described mode of operation, the data from the aircraft operational data sensors 17 to 23 may be provided directly to the transmitters 36 to 39 when one of the accident sensors 30 to 32 detects the occurrence of an accident event, without going through a black box. For example, the data from the operational data sensors 17 to 23 could be provided to the processor/modem 34 directly, which could format the aircraft operational data and send the data to the transmitters 36 to 39 for transmission upon receiving a triggering signal from the sensor interface 44 that is caused by the detection of an accident event by one or more of the accident sensors 30 to 32.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for transmitting aircraft operational data from an aircraft, comprising:
one or more black boxes that can store the aircraft operational data,
one or more transmitters that can wirelessly transmit the stored aircraft operational data from the aircraft; and
one or more sensors, each sensor being able to enable the wireless transmission of the aircraft operational data by the one or more transmitters upon sensing the occurrence of an event.

2. The system as claimed in claim 1, further comprising a processor/modem that receives aircraft operational data from the black box, compresses the aircraft operational data, and sends the compressed aircraft operational data to the one or more transmitters for transmission.

3. The system as claimed in claim 2, further comprising a bus to which the black box, the processor and the one or more transmitters are connected.

4. The system as claimed in claim 1, further comprising a ground-based receiver that receives the wirelessly transmitted aircraft operational data.

5. The system as claimed in claim 1, further comprising a satellite receiver that receives the wirelessly transmitted aircraft operational data.

6. The system as claimed in claim 1, wherein the one or more sensors includes a plurality of sensors, each of the plurality of sensors being able to enable the wireless transmission of the aircraft operational data by the one or more transmitters upon sensing the occurrence of an event.

7. The system as claimed in claim 1, wherein the one or more transmitters includes a plurality of transmitters and the one or more sensors includes a plurality of sensors, each of the plurality of sensors being able to enable the wireless transmission of the aircraft operational data by the plurality of transmitters upon sensing the occurrence of a predetermined event.

8. The system as claimed in claim 1, wherein the one or more black boxes includes a plurality of black boxes, each of the black boxes being able to store at least a part of the aircraft operational data.

9. The system as claimed in claim 1, wherein the black box is a flight data recorder.

10. The system as claimed in claim 1, wherein the black box is a cockpit voice recorder.

11. The system as claimed in claim 1, wherein the black box is a flight data recorder and a cockpit voice recorder.

12. The system as claimed in claim 1, wherein the one or more transmitters includes a plurality of transmitters and wherein each of the plurality of transmitters wirelessly transmits a portion of the aircraft operational data when enabled by the sensor.

13. The system as claimed in claim 12, wherein each of the plurality of transmitters transmits on a different frequency.

14. The system as claimed in claim 6, wherein the aircraft operational data includes:
sensor readings and control signals.

15. The system as claimed in claim 6, wherein the aircraft operational data includes voice signals.

16. The system as claimed in claim 15, wherein the aircraft operational data includes video signals.

17. A system for transmitting aircraft operational data from an aircraft, comprising:
a flight data recorder that can store a first set of the aircraft operational data;
a cockpit voice recorder that can store a second set of the aircraft operational data;
one or more transmitters that can wirelessly transmit the first and second set of the aircraft operational data; and
one or more sensors, each sensor being able to enable the wireless transmission of the first and second set of aircraft operational data upon sensing the occurrence of an event.

18. The system as claimed in claim 17, further comprising a processor/modem that receives the first and second set of aircraft operational data from the flight data recorder and from the cockpit voice recorder, respectively, compresses the first and second set of aircraft operational data, and sends the compressed first and second set of aircraft operational data to the one or more transmitters for transmission.

19. The system as claimed in claim 17, wherein the one or more sensors includes a plurality of sensors, each of the plurality of sensors being able to enable the wireless transmission of at least a portion of the first and second set of aircraft operational data by the one or more transmitters upon sensing the occurrence of an event.

20. The system as claimed in claim 17, wherein the one or more transmitters includes a plurality of transmitters and the one or more sensors includes a plurality of sensors, each of the plurality of sensors being able to enable the wireless transmission of the first and second set of aircraft operational data by the plurality of transmitters.

21. The system as claimed in claim 16, further comprising a ground-based receiver that receives the wirelessly transmitted aircraft operational data.

22. The system as claimed in claim 16, further comprising a satellite receiver that receives the wirelessly transmitted formatted aircraft operational data.

23. The system as claimed in claim 19, wherein the aircraft operational data includes:
sensor readings and control signals.

24. The system as claimed in claim 19, wherein the aircraft operational data includes voice signals.

25. The system as claimed in claim 24, wherein the aircraft operational data includes video signals.

26. A method of transmitting aircraft operational data from an aircraft, comprising the steps of:
storing aircraft operational data in a black box;
sensing the occurrence of an abnormal operational event in the aircraft; and
wirelessly transmitting the stored aircraft operational data upon sensing the occurrence of the abnormal operational event.

27. The method as claimed in claim 26, further comprising the step of compressing the aircraft operational data before performing the step of wirelessly transmitting the data.

28. The method as claimed in claim 26, further comprising the step of compressing the stored aircraft operational data.

29. The method as claimed in claim 26, wherein the stored aircraft operational data is transmitted with a plurality of transmitters.

30. The method as claimed in claim 27, wherein the stored aircraft operational data is transmitted with a plurality of transmitters.

31. The method as claimed in claim 26, further comprising the step of receiving the wirelessly transmitted aircraft operational data with a ground-based receiver.

32. The method as claimed in claim 26, further comprising the step of receiving the wirelessly transmitted aircraft operational data with a satellite receiver.

33. The method as claimed in claim 26, wherein the aircraft operational data includes:
sensor readings and control signals.

34. The method as claimed in claim 26, wherein the aircraft operational data includes voice signals.

35. The method as claimed in claim 34, wherein the aircraft operational data includes video signals.

36. A method of transmitting aircraft operational data from an aircraft, comprising the steps of:
storing a first set of the aircraft operational data in a flight data recorder;
storing a second set of the aircraft operational data in a cockpit voice recorder;
sensing the occurrence of an abnormal operational event in the aircraft, and
wirelessly transmitting the first and second set of the aircraft operational data upon sensing the occurrence of the abnormal operational event.

37. The method as claimed in claim 36, further comprising the step of compressing the first and second sets of the aircraft operational data before performing the step of wirelessly transmitting the data.

38. The method as claimed in claim 36, wherein the first and second set of the aircraft operational data are transmitted with a plurality of transmitters.

39. A system for transmitting aircraft operational data from an aircraft, comprising:
a black box that can store the aircraft operational data,
a processor/modem that receives the aircraft operational data from the black box and compresses the aircraft operational data;
a transmitter that can wirelessly transmit the compressed aircraft operational data from the aircraft; and
a sensor that enables the wireless transmission of the compressed aircraft operational data by the transmitter from the aircraft upon sensing the occurrence of an event.

40. The system as claimed in claim 39, further comprising additional black boxes, each of the black boxes being able to store at least part of the aircraft operational data.

41. The system as claimed in claim 39, further comprising additional transmitters, each of the transmitters being able to wirelessly transmit at least part of the aircraft operational data.

42. The system as claimed in claim 39, further comprising additional sensors, each of the sensors being able to enable the wireless transmission of the aircraft operational data by the transmitter upon sensing the occurrence of the predetermined event.

43. The system as claimed in claim 39, further comprising:
additional transmitters, each of the transmitters being able to wirelessly transmit the stored aircraft operational data from the aircraft; and
additional sensors, each of the sensors being able to enable the wireless transmission of the aircraft operational data by the transmitters upon sensing the occurrence of the predetermined event.

44. A system for transmitting aircraft operational data from an aircraft, comprising:
a flight data recorder that can store a first set of the aircraft operational data;
a cockpit voice recorder that can store a second set of the aircraft operational data;
a processor that receives the first and second set of aircraft operational data from the flight data recorder and from the cockpit voice recorder, respectively, and compresses the first and second set of aircraft operational data;
a transmitter that can wirelessly transmit the compressed first and second set of the aircraft operational data; and
a sensor that enables the wireless transmission of the compressed first and second set of aircraft operational data upon sensing the occurrence of an event.

45. A method of transmitting aircraft operational data from an aircraft, comprising the steps of:
storing aircraft operational data in a black box;
compressing the aircraft operational data;
sensing the occurrence of an abnormal operational event in the aircraft; and
wirelessly transmitting the compressed aircraft operational data upon sensing the occurrence of the abnormal operational event.

46. The method as claimed in claim 45, further comprising the step of receiving the wirelessly transmitted aircraft operational data with a ground-based receiver.

47. The method as claimed in claim 45, further comprising the step of receiving the wirelessly transmitted aircraft operational data with a satellite receiver.

48. A source of operational data from an aircraft, comprising:
a transmitter; and
one or more sensors disposed on the aircraft wherein the transmitter can transmit operational data from the aircraft in response to the detection of an abnormal operating event by one of the sensors.
